(19) United States
(12) Patent Application Publication
(10) Pub. No.: US 2013/0095293 A1
(43) Pub. Date: Apr. 18, 2013

(54) Shingle Coloring System

(71) Applicants: Daniel E. Boss, Murphy, TX (US); Michael L. Bryson, Independence, MO (US); Stephen A. Buzza, New Burgh, IN (US); Adem Chich, Kearny, NJ (US); Dale A. Kelley, Flower Mound, TX (US); Matti Kiik, Richardson, TX (US); Paul Richardson, Euless, TX (US); Tommy Rodrigues, Nutley, NJ (US); James A. Svec, Kilarny, NJ (US); James D. Wells, Bakersfield, CA (US)

(72) Inventors: Daniel E. Boss, Murphy, TX (US); Michael L. Bryson, Independence, MO (US); Stephen A. Buzza, New Burgh, IN (US); Adem Chich, Kearny, NJ (US); Dale A. Kelley, Flower Mound, TX (US); Matti Kiik, Richardson, TX (US); Paul Richardson, Euless, TX (US); Tommy Rodrigues, Nutley, NJ (US); James A. Svec, Kilarny, NJ (US); James D. Wells, Bakersfield, CA (US)

(21) Appl. No.: 13/274,148

(22) Filed: Oct. 14, 2011

(51) Int. Cl. E04D 1/28; B32B 11/10; D06N 7/04; B65B 55/00; B32B 38/08; B32B 11/02

(52) U.S. Cl. 428/147; 156/280; 156/276; 428/143; 428/148; 53/428; 442/64; 442/71; 442/65

(57) ABSTRACT

Disclosed painted roof coverings and related methods of manufacturing such painted roof coverings that use a color coating over the roof coverings instead of embedded pre-colored rock granules on the exposed surface of the roof coverings. By painting a roof covering with a color coating, any kind of top surfacing material, such as rock, plastic, mineral, man-made, or organic granules, may be used in place of the pre-colored rock granules. In some embodiments, it is desirable to size the top surfacing material to provide adequate UV protection and coverage to the weatherproofing asphalt material located below the top surfacing material. Further, the color of the shingles may be accurately matched between batches of shingles, between manufacturing facilities, and even between manufacturers. In addition, designs may be painted on the surface of the roof covering, which was previously impossible using pre-colored granules.

### TECHNICAL FIELD

The present disclosure generally relates to colored roofing shingles, and more particularly, to a method to color roofing coverings.

### BACKGROUND

In the manufacture of asphalt shingles, roll roofing, and some low-slope roofing membranes, color may be applied to the roofing surface by using either pre-made colored granules or naturally colored rock. The granule coverage of the shingles has two primary purposes. First, the pre-colored granules protect the water-shedding component of the shingle, which is most commonly a layer of asphalt, from outdoor weathering elements such as sunlight, rain, snow, and hail. Second, the pre-colored granules give the shingles a pleasing appearance as the roof constitutes a major portion of a house's aesthetic appearance.

Rock has been the most common material of choice in the United States to cover the asphalt layer in order to protect the asphalt layer from the sun's UV radiation. Without UV protection, the life of an asphalt-coated shingle would be short, maybe as low as 3 to 5 years. The addition of rock granules may increase the expected lifetime of asphalt-based shingles to 30 years or more.

The pre-colored granule rocks used are manufactured by two main suppliers-3M Corporation and ISP Minerals. Both of these manufacturers use a specific rock that has a very low translucency and use ceramic-type coatings to color the rocks used in asphalt shingles. The majority of the pre-colored granules are standard in size, typically referred to as Grade 11, although a smaller size rock is available, typically referred to as Grade 18.

The pre-colored ceramic coated granules may be supplied to a roofing manufacturer in bulk, either by railroad car or semi truck-load. The roofing manufactures then store each color of the pre-colored granules in a separate storage silo. When the roofing manufacturer wants to manufacture a run of shingles of a certain color, one or more colors of the pre-colored granules are pulled from storage silos in specific ratios or percentages and then are mixed in a blender or on a blend belt to create the desired final color. There may be two or more color blends used on any one shingle to make a shingle that appears pleasing to the eye. For example, the asphalt shingle color Weatheredwood may have five or more different pre-colored ceramic coated granules that are mixed in a specific ratio to create the appearance of the single color Weatheredwood from afar.

One approach used to apply the pre-colored granules to the heated asphalt shingle fabric is with a blender. The blender drops the pre-colored granules onto a asphalt-covered fiberglass mat web in distinct sections as it travels under the blender. Different sections of the web may receive the various colors of the pre-colored granules in different ratios and mixtures in order to make the finished shingle have a better aesthetic value.

One of the limitations of blending pre-colored granules, however, is that it is difficult to create consistency in final colors between manufacturing facilities or even between runs of shingles manufactured in the same facility. The cause of this limitation is that it is difficult for the pre-colored granules to be blended in exactly the same ratios between runs or between manufacturing facilities, and the pre-colored granules may come from different locations and may be slightly different in color to begin with. In addition, the pre-colored granules may appear slightly different based on the locations of the two manufacturing facilities and the rock supplier. The size and shape of each pre-colored granule may also be slightly different, which may change the final color of the shingle.

Because of the inherent limitations of mixing pre-colored granules to create a final color for asphalt shingles, roofers do not like to mix the same colored shingles that come from two different manufacturing facilities, even if the same manufacturer operates both facilities. Also, as a result of these limitations, roofing shingles manufacturers have been limited in the colors and patterns that they can apply to the asphalt surface due to the limited number of colors of pre-colored granules provided to them from the rock supplier. Even though limited in colors and color patterns by the pre-colored granules, changes in the production process may result in waste shingles and may require the production line to be shut down and/or equipment to be changed to produce a run of the next color of shingle.

### SUMMARY

In an embodiment, a colored roofing covering comprising a fiberglass mat comprising an upper surface and a lower surface; a first asphalt filled coating layer disposed on the upper surface of the fiberglass mat, wherein the first asphalt filled coating layer is operable to provide a substantially waterproof barrier for the upper surface of the fiberglass mat; a layer of top surfacing material disposed on the first asphalt filled coating layer; and a color coating layer disposed on the layer of top surfacing material may be disclosed.

In a further embodiment, a method for manufacturing a colored roofing covering comprising: providing a fiberglass mat comprising an upper surface and a lower surface; disposing a first asphalt filled coating layer on the upper surface of the fiberglass mat, wherein the first asphalt filled coating layer is operable to provide a substantially waterproof barrier for the upper surface of the fiberglass mat; disposing a layer of top surfacing material on the first asphalt filled coating layer; and disposing a color coating layer on the layer of top surfacing material may be disclosed.

In a further embodiment, A method for preparing packaged colored roofing coverings comprising: manufacturing a plurality of colored roofing coverings, the manufacturing comprising: providing a fiberglass mat comprising an upper surface and a lower surface; disposing a first asphalt filled coating layer on the upper surface of the fiberglass mat, wherein the first asphalt filled coating layer is operable to provide a substantially waterproof barrier for the upper surface of the fiberglass mat; disposing a layer of top surfacing material on the first asphalt filled coating layer; and disposing a color coating layer on the layer of top surfacing material; packaging the plurality of manufactured colored roofing coverings; and palletizing the packaged colored roofing coverings, may be disclosed.

### BRIEF DESCRIPTION OF THE DRAWINGS

FIG. 1A is a perspective drawing of a prior art roof;

FIG. 1B is a cross-sectional drawing of a prior art embodiment of an asphalt shingle;

FIG. 2 is a cross-sectional drawing of a painted roof covering, in accordance with the present disclosure; and

FIG. 3 is a flow diagram of a process for manufacturing the colored roofing covering of FIG. 2, in accordance with the present disclosure.

### DETAILED DESCRIPTION

Disclosed herein are painted roof coverings and related methods of manufacturing using paint and/or ink to replace pre-colored rock granules on the exposed surface of roof coverings. Any kind of rock, plastic, man-made, mineral, or organic substance sized to any functional dimension that provides adequate UV protection or coverage to a layer of waterproofing asphalt may be used and may be painted with a layer of paint or ink in any color, pattern, or design.

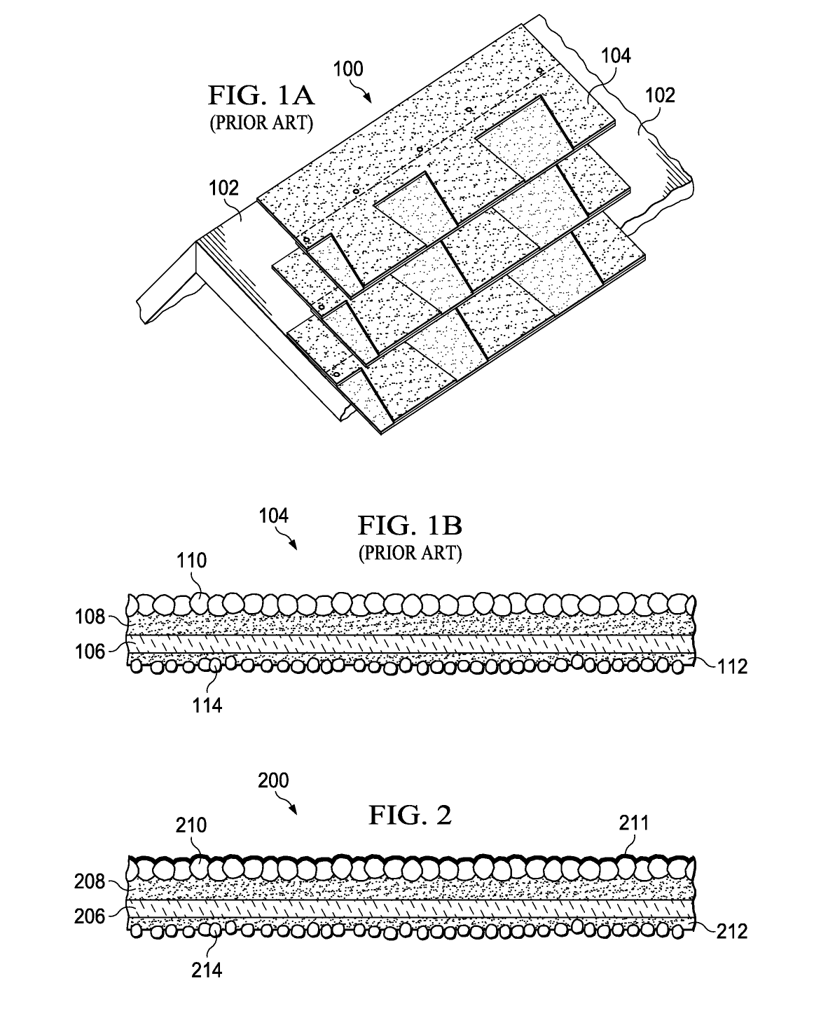

FIG. 1A is a prior art roof 100. The roof 100 may comprise a roof support 102 and roof coverings 104 covering the roof support 102. The roof 100 may be a pitched roof covered by asphalt shingles as the roof coverings 104. The roof support 102 may be comprised of beams and/or trusses (not shown) made from pressure treated wood, cast iron, or steel. The trusses may be covered with sheets of plywood, providing a continuous surface on the roof support 102 to which the roof coverings 104 may be affixed. Because the roof support 102 may be manufactured from wood, the roof support 102 may be susceptible to the elements, including rain, snow, hail, heat, and cold. Accordingly, the roof support 102 may be protected from the elements by the roof coverings 104 and a layer of underlayment (not shown) disposed therebetween. According to local building code, the layer of underlayment (not shown) may be required by law and may be applied directly to a plywood roof support 102 below the roof coverings 104. The roof coverings 104 used to protect the roof support 102 from the elements may be asphalt shingles covered with pre-colored rock granules, as described in more detail below.

FIG. 1B is a cross-sectional drawing of a prior art asphalt shingles 104 of FIG. 1A. The asphalt shingles 104 may comprise various layers, including a fiberglass mat 106 and an asphalt filled coating 108 disposed thereon. The asphalt filled coating 108 may provide a waterproof barrier for the asphalt singles 104, protecting the fiberglass mat 106 and the roof support below (not shown) from the elements. A layer of pre-colored rock granules 110 may be disposed on top of the asphalt filled coating 108. As discussed previously, a primary purpose of the layer of pre-colored granules 110 is to protect the asphalt filled coating 108 from outdoor weathering elements, such as UV light from the sun, that may break down the asphalt filled coating 108 over time. The pre-colored granules 110 also give the shingles 104 their color, contributing to the house's esthetic appearance, although the shingles 104 are limited in color to the combinations possible by blending the pre-colored granules 110.

The asphalt shingles 104 may further comprise a second layer of asphalt filled coating 112 disposed beneath the fiberglass mat 106, further contributing to the waterproofing properties of the shingles 104. A back surfacing material 114 may be disposed beneath the second layer of asphalt filled coating 112, and may be in direct contact with the layer of plywood of the roof support 102, as shown in FIG. 1A. As discussed previously, certain problems may be associated with using pre-colored granules 110 during the manufacturing process of asphalt shingles 104. Accordingly, a system and method for manufacturing asphalt shingles without requiring the use of pre-colored granules to make up the color of the asphalt singles 104 is desired.

FIG. 2 is a cross-sectional drawing of a colored roof covering 200, in accordance with the present disclosure. The colored roof covering 200 may comprise a fiberglass mat 206, an asphalt filled coating 208 disposed on top of the fiberglass mat 206, a second asphalt filled coating 212 disposed beneath the fiberglass mat 206, and a layer of back surfacing material 214 disposed over the second asphalt filed coating 212.

The colored roof covering 200 may further comprise a layer of top surfacing material 210 disposed on top of the asphalt filled coating 208. The layer of top surfacing material 210 may replace the pre-colored granule surface with similarly-sized minerals or rocks, such as limestone, that may be painted in-line. The colored roof covering 200 may use only one layer of top surfacing material 210 that may be comprised of individual granules. The granules may be rock, clay, manufactured mineral, polymer plastic, or metal flake material and may be applied to the asphalt filled coating 208. Because certain types of rocks are more readily available in specific parts of the United States, roofing manufacturers may be able to reduce manufacturing costs by using those rocks most readily available in close proximity to each manufacturing facility.

The exposed portion of the colored roof covering 200 is typically referred to as the buttlap portion of the shingle and is the portion of the shingle to which a layer of color coating 211 may be applied during the painting process. The layer of top surfacing material 210 may be coated with the color coating 211 that provides a substantially uniform painted surface and allows the colored roof covering 200 to be painted with a design, pattern, or logo, which may not be possible with a shingle covered by pre-colored granules. Whereas the pre-colored granules 110 in FIG. 1 have a conformal layer of color coating over each individual granule, the color coating 211 may be a conformal layer over the layer of top surfacing material 210 but not over the entire surface of each individual particle that may make up the layer of top surfacing material 210.

The color coating 211 may be either a paint that is painted onto the layer of top surfacing material 210 or an ink that is applied with an ink jet printer onto the layer of top surfacing material 210. By using the color coating 211 instead of pre-colored granules, unlimited shingle colors and/or patterns may be possible by mixing two or more colors during the application process. The color coating 211 may be designed to be out in the elements for the lifetime of the colored roof covering 200, which could be up to 30 years or more depending on the particular shingle being manufactured. The color coating 211 may also be designed to resist fading when exposed to 30 years of sunlight, rain, and snow.

An industrial painting system such as those manufactured by Nordsen or Cefla may be used to apply the color coating 211 with a computer controlled painting system. The painting system may be set up to be pre-programmed with the desired colors and/or color patterns. In an exemplary embodiment of a painted color coating 211, suggested paints may include acrylic-based paints, oil-based paints, polyurethane acrylate-based paints, polyvinylidene fluoride-based paints (PDVFs), or any combination thereof. In some embodiments, weathering properties from the colored roof covering 200 using the color coating 211 may be optimized wherein at least 70% of the material is the PVDF. With the current formulation of paints available, the paint or ink coating 211 may be applied as thin as 5 microns thick. There are numerous potential suppliers of these types of paints, including companies such as Sherwin Williams and Arkema.

Alternatively, an industrial ink-jet system such as those supplied by Electronics for Imaging, Inc. (EFI) may be used to apply an ink color coating 211 with a computer controlled system. The industrial ink-jet system may work similarly to the ink-jet desktop printers used in many homes and offices. In an exemplary embodiment of ink color coating 211, the components of the color coating 211 may include a combination of oligomers, monomers, a photo initiator, colorants, and modifiers and additives. There are numerous potential supplies of these types of ink, including companies such as Sartomer.

An optional layer of pre-coating covering (not shown) may be applied on top of the layer of top surfacing material 210 before the layer of color coating 211 is applied. The layer of pre-coating may be used to achieve a more consistent shingle color between manufacturing plants and/or production lines if the same layer of top surfacing material 210 is not used consistently between manufacturing plants and/or production lines. The layer of pre-coating may be a neutral color, which may allow a manufacturer to change the layer of top surfacing material 210 during production without having to be concerned about the finished color of colored roof covering 200 differing slightly from another run of painted shingles.

Additionally, a layer of clear coating (not shown) may also be optionally applied on top of the layer of color coating 211. The layer of clear coating may be used to achieve the desired shingle appearance and/or may be used to provide the desired life expectancy of the shingle, which could be 30 years or more with today's shingles.

By utilizing the color coating 211, the roofing manufacturer may no longer have to have separate storage silos for each color of pre-colored granules and would potentially only need one or two storage silos for all of the granules or other materials that make up the layer of top surfacing material 210, depending on the rate of production and how quickly the stock of the layer of top surfacing material 210 can be refilled by suppliers. Furthermore, with a color coating 211, the layer of top surfacing material 210 may not need to be made from a specific material and may be purchased locally based on the availability and price of what may be available closest to each manufacturing facility. Even if two different manufacturing facilities use different layers of top surfacing materials 210, perfect color matching between manufacturing facilities may be achieved by using the same color coating 211 because manufacturing facilities would no longer have to be concerned with using the exact same ration of colors of pre-colored granules when trying to match colors between manufacturing facilities and/or production lines.

The color coating 211 on top of the layer of top surfacing material 210 may further help to control manufacturing and inventory costs because scrap from color changes normally associated with pre-colored granules may be significantly reduced and there may be reduced inventory control complexity required because the raw layer of top surfacing material 210 would not have to be stored in separate silos based on their original colors. Further, the total mass of the colored roof covering 200 may be reduced because the need for the pre-colored granules may be eliminated and may not actually be as important to the appearance of the colored roof covering 200 as it is with a traditional asphalt shingle with pre-colored granules. Smaller sized and/or lighter weight granules, such as Grade 18 granules, may be used for the layer of top surfacing material 210, and less asphalt filled coating 206 may be necessary to bond the smaller particles of the layer of top surfacing material 210 to the fiberglass mat 206.

Even further, the color coating 211 on top of the layer of top surfacing material 210 may synergistically help to extend the life of the colored roof covering 200. The top surfacing material 210 protects the layers beneath from outdoor weathering elements such as sunlight, rain, snow, and hail. The color coating 211 may form a film barrier over the top surfacing material 210 and provide additional protection against erosion by air, moisture, and/or UV light. In comparison, the shingle 104 shown in FIG. 1B has only the pre-colored granules 110 to protect the filled coating 108 from weathering elements. By incorporating the color coating 211 into the colored roof covering 200 of FIG. 2, additional time is required for the weathering element to penetrate the additional barrier provided by the color coating 211, thereby extending the life of the colored roof covering 200.

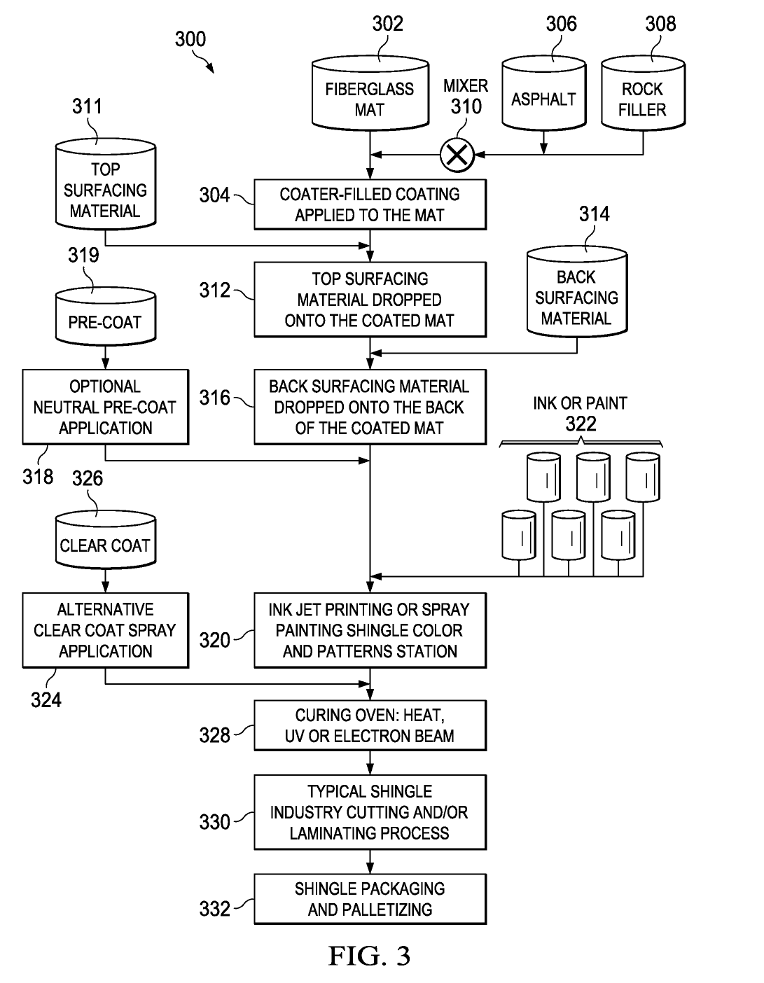

FIG. 3 is a flow diagram of a process 300 for manufacturing the colored roofing covering of FIG. 2, in accordance with the present disclosure. In an embodiment, asphalt shingles are made on a web of non-woven fiberglass material comprising a fiberglass mat 302, wherein the web can range from approximately 36″wide to 68″ wide, although larger and smaller webs may also be used. In operation, the process 300 begins with the fiberglass mat 302 as the skeleton upon which the rest of the layers of a colored roofing covering are added. At action 304, asphalt 306 and rock filler 308 may be mixed together in a mixer 310, creating the asphalt filled coating 306, 308, and then the asphalt filled coating 306, 308 may be applied to the top and the bottom surfaces of the fiberglass mat 302, respectively as the fiberglass mat 302 is fed through a roller. At action 312, a layer of top surfacing material 311 may be dropped onto a top surface of the asphalt filled coating 306, 308 that was applied on top of the fiberglass mat 302. At action 316, a layer of back surfacing material 314 may be dropped onto a bottom surface of the asphalt filled coating 312 that was applied to the bottom of the fiberglass mat 302.

At optional action 318, a neutral pre-coat 319 may be applied on top of the layer of top surfacing material 310. The neutral pre-coat 319 may be necessary to achieve consistent shingle colors between manufacturing facilities. At action 320, a color coating 322 may be applied to the layer of top surfacing material 310 and/or neutral pre-coat 319 layer to form a color way. If the color coating 322 is an ink, the color coating 322 may be applied with an industrial-sized ink jet printer. If the color coating 322 is a paint, the color coating 322 may be applied by an automated spray painter. The color coating 322 may be stored in storage tanks (not shown) based on the color or the paint or ink. The color coating 322 may be applied as a single color, as a uniform mixture of two or more colors, as a speckled color, or as a pattern or design. At optional action 324, a clear coating 326 may be applied on top of the layer of paint or ink coating 322. The clear coating 326 may be necessary to achieve the desired shingle appearance and/or to improve the expected lifetime of the shingle by further protecting the colored roofing covering from UV light.

At action 328, the colored roofing covering may be cured by heat, UV light, or electron beam in order to cure the various layers of the colored roofing covering together and to prevent the color coating 322 from running. At action 330, as the colored roofing covering is being cooled after curing, the colored roofing covering may be cut and/or laminated, as is typical in the shingle industry. The sheet of colored roofing covering may be cut into lanes that are either cut into individual shingles or into lanes that may be laminated together into multi-layer strips, which may be later cut into individual shingles. At action 332, the colored roofing covering may be packaged and palletized. At this point, the packaged colored roof coverings may be ready to be shipped from the manufacturing facility to a wholesaler, a retailer, a roofing contractor, or directly to an end consumer.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A colored roofing covering comprising:
a fiberglass mat comprising an upper surface and a lower surface;
a first asphalt filled coating layer disposed on the upper surface of the fiberglass mat, wherein the first asphalt filled coating layer is operable to provide a substantially waterproof barrier for the upper surface of the fiberglass mat;
a layer of top surfacing material disposed on the first asphalt filled coating layer; and
a color coating layer disposed on the layer of top surfacing material.

2. The colored roofing covering of claim 1, wherein the layer of top surfacing material comprises a plurality of individual granules.

3. The colored roofing covering of claim 2, wherein the individual granules are selected from the group consisting of rock, clay, polymer plastic, manufactured mineral, organic compound, or metal flake.

4. The colored roofing covering of claim 3, wherein the individual granules are Grade 18 sized granules.

5. The colored roofing covering of claim 1, wherein the color coating layer comprises a layer of paint.

6. The colored roofing covering of claim 5, wherein the paint selected from the group consisting of acrylic-based paints, oil-based paints, polyurethane-based paints, polyurethane acrylate-based paints, polyvinylidene fluoride-based paints, or any combination thereof.

7. The colored roofing covering of claim 5, wherein the color coating layer is applied approximately 5 microns thick.

8. The colored roofing covering of claim 1, wherein the color coating layer comprises a layer of ink.

9. The colored roofing covering of claim 8, wherein the ink comprises at least two of the following: oligomers, monomers, a photo initiator, colorants, modifiers, and additives.

10. The colored roofing covering of claim 1 further comprising a pre-coat layer disposed between the layer of top surfacing material and the color coating layer.

11. The colored roofing covering of claim 1 further comprising a clear-coat layer disposed on top of the color coating layer.

12. The colored roofing covering of claim 1, further comprising a second asphalt filled coating layer disposed on the lower surface of the fiberglass mat, wherein the second asphalt filled coating layer is operable to provide a substantially waterproof barrier for the lower surface of the fiberglass mat.

13. The colored roofing covering of claim 1, further comprising a layer of back surfacing material disposed on the second asphalt filled coating layer.

14. A method for manufacturing a colored roofing covering comprising:
providing a fiberglass mat comprising an upper surface and a lower surface;
disposing a first asphalt filled coating layer on the upper surface of the fiberglass mat, wherein the first asphalt filled coating layer is operable to provide a substantially waterproof barrier for the upper surface of the fiberglass mat;
disposing a layer of top surfacing material on the first asphalt filled coating layer; and
disposing a color coating layer on the layer of top surfacing material;

15. The method for manufacturing the colored roofing covering of claim 14, wherein the layer of top surfacing material comprises a plurality of individual granules.

16. The method for manufacturing the colored roofing covering of claim 14, wherein disposing a color coating layer comprises spraying a layer of paint and controlling the spraying with a computer.

17. The method for manufacturing the colored roofing covering of claim 14, wherein disposing a color coating layer comprises inject a layer of ink and controlling the injecting with a computer.

18. The method for manufacturing the colored roofing covering of claim 14, further comprising disposing a pre-coat layer between the layer of top surfacing material and the color coating layer.

19. The method for manufacturing the colored roofing covering of claim 14, further comprising disposing a clear-coat layer on top of the color coating layer.

20. The method for manufacturing the colored roofing covering of claim 14, further comprising disposing a second asphalt filled coating layer on the lower surface of the fiberglass mat, wherein the second asphalt filled coating layer is operable to provide a substantially waterproof barrier for the lower surface of the fiberglass mat.

21. The method for manufacturing the colored roofing covering of claim 14, further comprising disposing a layer of back surfacing material on the second asphalt filled coating layer.

22. The method for manufacturing the colored roofing covering of claim 14, further comprising packaging the manufactured colored roofing covering.

23. The method for manufacturing the colored roofing covering of claim 14, further comprising palletizing the packaged colored roofing covering.

24. A method for preparing packaged colored roofing coverings comprising:
manufacturing a plurality of colored roofing coverings, the manufacturing comprising:
providing a fiberglass mat comprising an upper surface and a lower surface;
disposing a first asphalt filled coating layer on the upper surface of the fiberglass mat, wherein the first asphalt filled coating layer is operable to provide a substantially waterproof barrier for the upper surface of the fiberglass mat;
disposing a layer of top surfacing material on the first asphalt filled coating layer; and
disposing a color coating layer on the layer of top surfacing material;
packaging the plurality of manufactured colored roofing coverings; and palletizing the packaged colored roofing coverings.
